(19) United States
(12) Patent Application Publication
(10) Pub. No.: US 2004/0024742 A1
(43) Pub. Date: Feb. 5, 2004

(54) Computer system

(75) Inventor: Jurgen Angele, Herxheim (DE)

Correspondence Address: VENABLE, BAETJER, HOWARD AND CIVILETTI, LLP, P.O. BOX 34385, WASHINGTON, DC, 20043-9998, US

(73) Assignee: ONTOPRISE GMBH, Karlsruhe (DE)

(21) Appl. No.: 10/629,587

(22) Filed: Jul. 30, 2003

Related U.S. Application Data
(63) Continuation-in-part of application No. PCT/EP02/00913, filed on Jan. 30, 2002.

(30) Foreign Application Priority Data
Jan. 30, 2001 (DE) 101 03 845.3

(51) Int. Cl. G06F 7/00

(52) U.S. Cl. 707/1

(57) ABSTRACT

A computer system and method for efficient storage and retrieval of data. The inventive computer system may comprise means for storing data, wherein data are allocated to predetermined categories that are components of at least one stored categorical structure forming an object model, wherein attributes that are passed on within the categorical structure are allocated to the categories; at least one inquiry unit for making inquiries relating to the stored data; and at least one inference unit used to evaluate rules linking at least one of said categories and said attributes.

### CROSS-REFERENCE TO RELATED APPLICATION

This application is a continuation-in-part of PCT International Application No. PCT/EP02/00913, filed Jan. 30, 2002, incorporated herein by reference, which claims the priority of German Patent Application No. 101 03 845, filed on Jan. 30, 2001.

### FIELD OF THE INVENTION

The present invention addresses computer systems and methods for the efficient storage and recovery of information.

### DESCRIPTION OF RELATED ART

Computer systems of the type with which the present invention is concerned are often formed with computer units connected into a network, which are provided with integrated means for storing data, especially database systems. In particular, the computer units can also be connected to the Internet, so that an inquiry to the database systems can be sent via the Internet.

Database systems of this type generally contain large data records that can be queried with the aid of specific inquiry commands. One major problem occurring in particular with database systems containing large amounts of stored data is the fact that suitable inquiry commands must be defined for obtaining the desired search results.

Searches of this type are particularly difficult if data is requested that deals with general subjects, but only a few searchable data terms are known for the defined subjects. For example, suppose that a computer system comprises database systems in which different types of publications from the technical, medical and business fields are stored. A user of the database system knows the name of an author of a publication, but knows no information other than that the publication is a technical publication. Thus, the single search term available to the user is the name of the author of this publication. This name is used as input variable for the search and is input into the computer system by using an inquiry unit. Because no other information is available, the user must then search through all the inquiry material relating to the searched name to find the desired publication, if necessary using additionally obtained information on the author. An additional manual evaluation of this type is extremely tedious and is also the source of many errors, so that the search result is subject to considerable inaccuracies.

### SUMMARY OF THE INVENTION

It is an object of the present invention to create a computer system of the aforementioned type and an associated method to ensure the most comprehensive, simple and flexible access to information stored in the computer system.

According to a first exemplary embodiment, the invention comprises a computer system that includes data storage means and an inquiry unit for determining output variables by accessing data stored in the data storage means. The data in the data storage means are stored according to predetermined categories that are components of at least one categorical structure forming an object model. Attributes that are passed on within a categorical structure are allocated to the categories. At least one inquiry unit is used as an inference unit to evaluate rules linking predetermined categories and/or attributes. By thus applying the inference unit, it is possible to create linkages among various categories and attributes.

According to a second exemplary embodiment of the invention, methods are provided for storing and retrieving data in a computer system. A categorical structure is generated in the form of an object model, having categories and associated attributes. The categories and attributes are distributed within the categorical structure according to the structure. Data is then stored in the various categories according to the attributes of the data. Inquiries are processed, during which processing rules for linking categories and/or attributes are evaluated. A predetermined subset or a correlation between or among subsets of categories and/or attributes and/or data may be derived as output variables in response to an inquiry. Interrelations among various categories, attributes and data may also be provided as output variables.

A computer system according to the invention may comprise a network of computers, and the network connecting the computers may, for example, be the Internet. Accordingly, the inventive method may be implemented across such a network of computers. Each computer may be equipped with data storage means and/or inquiry means and/or inference means.

The method may be implemented in the form of software code contained in a computer-readable medium, such as a hard disk, a floppy disk, a CD-ROM, RAM, ROM, PROM, etc. A computer system according to the present invention may be equipped with suitable means to read and execute the software code from the computer-readable medium, and may further contain one or more processors and one or more data storage means. The software code may further be communicated between or among various computer systems by means of a communications medium having a data-modulated signal that has been modulated according to the software code.

The data storage means may comprise any memory means, including RAM, ROM, hard disk, etc. It may also comprise multiple memory devices, including multiple devices associated with multiple computers (i.e., it may be “distributed”).

Thus, the invention is based upon the basic idea that the data stored in the computer system are structured within at least one object model, preferably within several object models. Object models, which form ontologies of this type, are divided into categories with hierarchical or associative structures, wherein several attributes that are passed on within a categorical structure are preferably allocated to the categories. According to the invention, the information stored in the computer system may be accessed, but need not be solely accessed, by an inquiry of the data stored therein. Instead, the computer system according to the invention is provided with a pre-defined number of rules that are allocated to at least one inference unit.

Attributes of at least one categorical structure and/or categories of at least one categorical structure, and if necessary, also stored data, can thus be linked with the aid of the rules. The rules here represent the logical linking instructions, which relate the individual aforementioned elements in the pre-defined manner to each other. An evaluation is made in the inference unit by allocating concrete values for the attributes, categories and/or data to these rules, thus generating specific output variables.

According to the invention, the inquiry and evaluation of information is thus not limited to the level of the data stored in the computer system. Rather, the inquiries are expanded to include structural elements of the object models used to structure the data. As a result, even complex facts and interrelations can be extracted from the information stored in the computer system using only rudimentary and simple inquiries and/or input values.

A computer unit with an integrated database system, structured as discussed above, represents a simple example of a type of computer system according to the invention. An inquiry relating to specific categories or attributes makes it possible to obtain data subsets as output variables without a direct inquiry about the data itself. Inquiry sequences of this type are particularly advantageous because data can be categorized according to easily searched specific criteria and characteristics with the categories and attributes of categorical structures. For example, personnel data can be structured so as to be divided into different categories that are based on the employee hierarchy of a company. A categorical structure of this type may, for example, contain the category “employees” on a first level, which is then divided further into the sub-categories “technical employees” and “clerical employees.” These sub-categories can be divided further into additional sub-categories to which the gender of an employee or other characteristics can be allocated as attributes.

With a computer system and method according to the invention, an inquiry of specific categories and attributes can be used to determine the employees allocated to these elements without necessitating a direct inquiry into the concrete data for these employees, e.g., name, address and department designation within the firm. An especially powerful and flexible inquiry system is thus created as a result of the option of processing an inquiry in the category and/or attribute level above the data level, which considerably expands the search options as compared to traditional database systems.

Another advantage of the inventive method and computer system is that a user can enter several inquiry terms as input variables into the computer system without having to make a distinction whether these inquiry terms are data, categories or attributes to be searched. These inquiry terms, as input variables, are linked in the inference unit with rules allocated to the respective inquiry command. With the aid of these rules, the inquiry commands are allocated to the data, categories and/or attributes of an object model. Data subsets are obtained as output variables, which are at a predetermined correlation to each other, depending on the setup for these rules. In the simplest case, the inquiry terms are linked to form a single output variable.

According to another advantageous embodiment, correlation among attributes, categories and/or data for the various object models can be obtained with the inference unit and the rules allocated to this unit. That is, correlations among various attributes, categories and/or data may be determined, e.g., during the processing involved with data retrieval.

A system of this type can advantageously be used as interface unit between two different computer units, connected into a network. Two database systems that are integrated into the computer units of two different firms represent one example for this. Data is to be transferred between both database systems automatically, if possible, via a computer network and, in particular, via the Internet. Requirements of this type arise particularly in the area of e-commerce. For example, systems of this type should automatically handle orders between manufacturing firms and their authorized suppliers. However, the different schemata used for storing data in the database systems of different firms present a problem. Accordingly, the object models for structuring the individual database systems differ significantly. At least one inference unit is, therefore, allocated to these database systems as an interface unit to ensure, nonetheless, a non-problematic data transfer between the database systems. The rules allocated to the inference unit translate the structures of the object model for one of the database systems into the object model of the second database system. As a result, a defined allocation of the transferred data is always ensured during a transfer of data from one database system to another.

### BRIEF DESCRIPTION OF THE DRAWINGS

The invention is explained in the following with the aid of the drawings, in which:

FIG. 1 shows a configuration of a first exemplary embodiment of a computer system according to the invention;

FIG. 2 shows object models for structuring the data stored on the computer system according to FIG. 1;

FIG. 3 shows a configuration of a second exemplary embodiment of a computer system according to the invention; and

FIG. 4 shows object models for structuring data stored on the computer system according to FIG. 3.

### DETAILED DESCRIPTION OF PREFERRED EMBODIMENTS

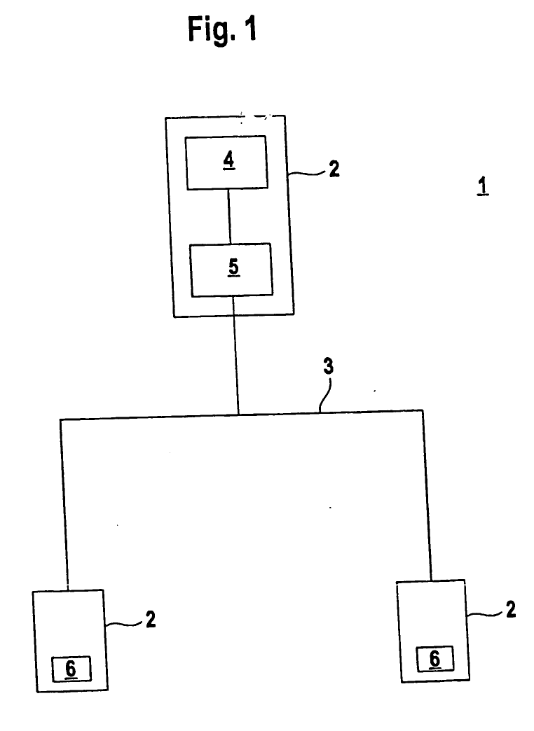

FIG. 1 schematically shows the basic configuration of a first exemplary embodiment of a computer system 1 according to the invention. The computer system 1 comprises several computer units 2 that are connected into a network via computer lines 3. One of the computer units 2 is a central computer containing stored data. A database system 4 functions as a means for storing the data. An inference unit 5 is provided for processing and evaluating inquiries to the database system 4.

Several users can access the database system 4 via additional computer units 2, e.g., personal computers, which are connected into the network. The computer units 2 are provided for this purpose with suitable input/output units 6, having terminals that are not separately shown in FIG. 1.

The Internet, in particular, can function as the network, in which case the computer units 2 are provided with respective Internet connections.

Object models, so-called ontologies, are used for structuring the data stored in the database system 4. An object model is divided into categories forming a structure, wherein the structure can be a hierarchical structure. With hierarchical structures, the categories in a predetermined level are respectively allocated to precisely one category of a superior level, meaning only single inheritances are permitted. In general, the categorical structure can also be more generally embodied as an acyclic graph for which multiple inheritances are permitted.

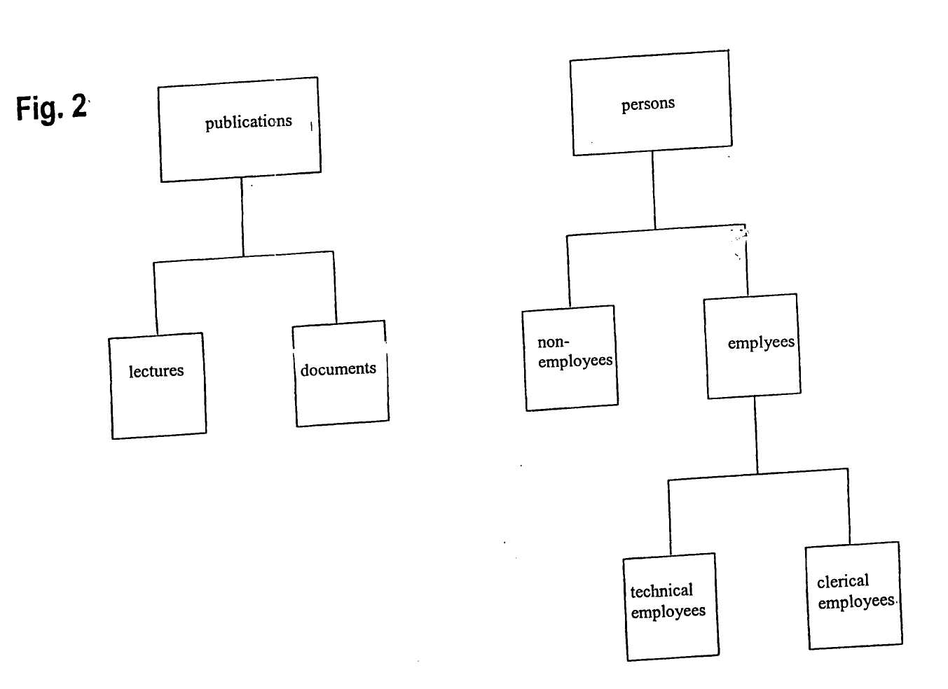

FIG. 2 shows examples of two such hierarchical categorical structures that respectively form one object model. The first object model contains a “publications” category to which the sub-categories “lectures” and “documents” are allocated. The second object model contains a “persons” category to which the sub-categories “non-employees” and “employees” are allocated, and the additional sub-categories “technical employees” and “clerical employees” are allocated to the sub-category “employees.”

Specific attributes may be allocated to the categories of a hierarchical categorical structure. In the process, an attribute allocated to a category, e.g., the category “persons,” is passed on to the sub-categories of this category. An attribute of this type, for example, can be a name. For the present example, this attribute is passed on within the categorical structure to the sub-categories “non-employees” and “employees,” as well as to the sub-categories for this latter category, “clerical employees” and “technical employees.” A particularly efficient structuring of the data in the database system 4 is created as a result.

Rules are allocated to the inference unit 5 for processing inquiries to the database system 4. These rules are stored in the inference unit 5 itself or in a memory unit that is allocated to the inference unit 5, but which is not shown in FIG. 1.

The number of rules and the development of these rules are adapted to the patterns for the inquiries to be processed and are preferably input during the installation of the inference unit 5 by an authorized operator, e.g., a so-called “knowledge engineer.”

The object models, as well as the language for these rules, can differ. In one exemplary implementation of the invention, the object models are preferably of the type DAML+OIL, while DAML−L is used as the rule language.

To process inquiries to the database system 4, defined inquiry commands are entered into the input/output unit 6. Depending on the format for a given inquiry command, a series of rules is processed in the inference unit 5. Since the rules in general are a declarative system, the sequence for the definition of the rules is not important.

The rules involve logical links between categories and/or attributes and/or data of the database system 4. The rules allocated to an inquiry command for generating defined output variables are evaluated in the inference unit 5. It is useful if the output variables are subsequently output via the input/output unit 6.

Linking attributes and categories via a predetermined number of rules makes it easy to process an inquiry of data subsets in the database system 4 without having to refer to specific data in the inquiry commands. As compared to traditional database systems 4 where the inquiry commands are limited to the data level, the option of processing an inquiry on the category and attribute levels allows for a considerable expansion and higher flexibility of the processing options.

For example, an inquiry command may, in a particular implementation of the invention, have the following format:

“Output the names for all data stored in the hierarchy of the categorical structure for the object model “persons” below the level “employees.”

The names of all technical and scientific employees stored in the database system 4 are then displayed for the user as output variable.

In another advantageous embodiment, interrelations between different attributes, categories and/or data can be created with the rules allocated to the individual inquiry commands. In particular, attributes, categories and/or data from the various categorical structures can also be linked with the rules.

A particular advantage is that the user only needs to input the terms for processing the search, preferably in sequence, when entering the inquiry command. The user is not required to define whether these terms relate to categories, attributes or data. In addition, the user is not required to intervene in the structure for the rules, which are allocated to a specific inquiry command. The inference unit 5 automatically allocates the terms to the rules and processes the rules.

One example of an inquiry of this type can be structured as follows. A user would like to inquire about the level of knowledge of a person, known to the user, with the name “Mustermann.” The user thus enters the two search variables “Mustennann” and “knowledge” into the input/output unit 6.

The rules allocated to this inquiry command are evaluated in the inference unit 5, wherein such a rule can be worded as follows:

“If a person writes a document, and the document deals with given subject matter, then this person has knowledge of the subject matter.”

The categories “persons” and “document” from two different categorical structures are linked in this way. Reference is made in the process to the subject of documents, wherein the subjects of the documents, for example, are allocated as data to the category “document.”

Whether or not a person has “knowledge” of this subject is obtained as an output variable for this rule.

The example shows that the inquiry not only obtains information stored in the database system 4 as a result of such links. Rather, rules of this type establish interrelations between elements in database systems 4, such that new characteristic variables can be derived, if necessary.

In the inference unit 5, this rule is evaluated in dependence on the input variables “knowledge” and “Mustermann” with the aid of an allocation diagram stored therein, which reads as follows for the present example:

Mustermann is a person.

Mustermann is the author of a dissertation.

The subject matter of this dissertation is biotechnology.

The dissertation is a document.

Using the aforementioned rule for evaluating these allocations results in showing that “Mustermann” has knowledge of biotechnology. The result is preferably output via the input/output unit 6. The above-mentioned allocations are implemented, for example, by a maintenance user in the inference unit.

One essential difference between this system and known database systems is that the search result “Mustermann has knowledge of biotechnology” was not obtained either through an inquiry of the database with the term “knowledge” nor with the term “biotechnology.”

Processing an inquiry with the term “biotechnology” in a traditional database system would require that the user already has detailed information concerning the knowledge of Mustermann. Furthermore, the term “biotechnology” would have to be enqueued explicitly in a data record allocated to the person Mustermann.

Processing an inquiry with the term “knowledge” in principle would not make sense for a traditional database system because the abstract term “knowledge” can not be allocated to a concrete fact “biotechnology.”

In contrast, the computer system according to the invention links abstract terms, such as categories and/or attributes, with the aid of rules and provides new characteristic variables as output variables, as for the case at hand. These characteristic variables can then form abstract variables that can be researched directly by the user. The inference unit then automatically allocates concrete values directly to abstract variables by using the rules.

The example shows that, compared to traditional database systems, considerably less pre-knowledge, and thus also less information, is required for the computer system according to the invention to arrive at precise search results.

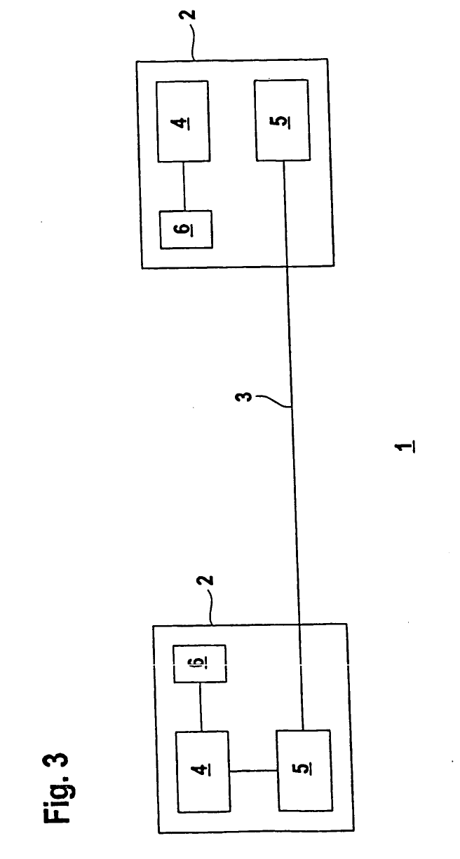

FIG. 3 shows a different exemplary embodiment of a computer system 1. This computer system comprises two computer units 2 that are connected into a network with the aid of computer lines 3. A database system 4 is implemented on each computer unit 2. The first computer unit 2 is located at a firm A while the second computer unit 2 is located at a firm B, wherein each computer unit 2 is provided with an input/output unit 6 for the operation.

The object involves setting up an automatically processed bi-directional information exchange, for example, to ensure that orders are received and processed electronically between two firms.

One problem that generally occurs is that even though database systems 4 in principle administer the same type of data, the data are stored under different schemata. As a result, the data records for two different database systems 4 are generally incompatible, thus making an automatic information transfer impossible.

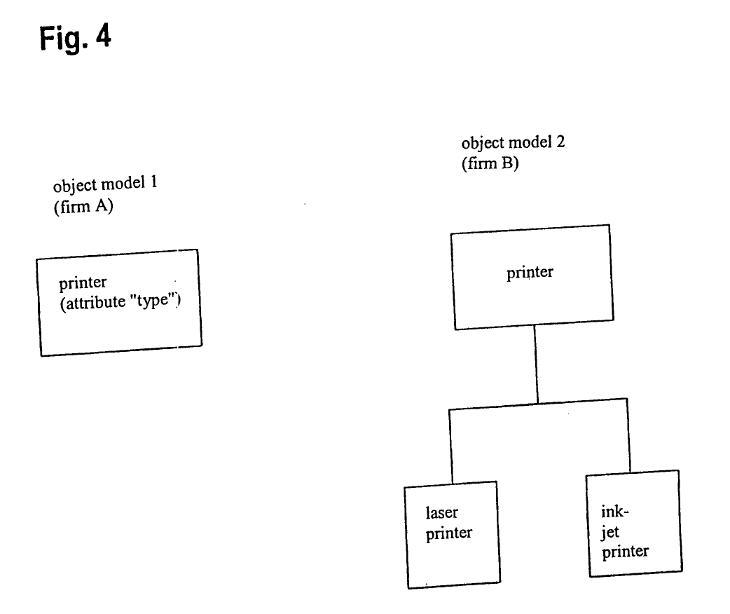

FIG. 4 contains one such example, wherein the database system 4 of firm A is patterned according to an object model 1.

According to this model, printers produced by the firm A are allocated to a category for “printers.” A differentiation is made within this category between different types of printers, e.g., inkjet printers and laser printers, by using an attribute for “type.” The firm B also produces printers, which are stored in the respective database system 4 based on an object model 2. This object model has a hierarchical categorical structure in which different printer types (laser printer, inkjet printer) are allocated as sub-categories to the category for “printers.”

Since the database systems 4 are structured according to different object models, data from one database system 4 can not be transferred directly to the respectively other database system 4.

To ensure, nonetheless, an automatic information exchange, an inference unit 5 is allocated to at least one database system 4 as an interface unit for information exchange between the different database systems 4. For the present embodiment, an inference unit 5 is allocated to each database system.

The inference unit 5 in the present case is operated without the aid of an input/output unit 6. Instead, the inference unit 5 defines the interrelations between categories and/or attributes of both object models, thus making it possible to obtain a clear allocation of the information in both database systems 4. As a result, the automatic exchange of information between both database systems 4 is made possible.

One example for a rule of this type is worded as follows: “If a printer by the firm A (object model 1) contains the word laser in an attribute for “type,” it belongs to the sub-category “laser printer” of the object model 2 (firm B).

Thus, this rule clearly allocates laser printers during an information transfer from firm A to firm B (or vice versa). An analogous rule can be formulated for inkjet printers.

Alternatively, the rule can also be worded generally, such that a clear allocation is made possible for the laser printer as well as for the inkjet printer. A generalized rule may read as follows: “If the value X of the attribute belongs to the category printers in the object model 1 (firm A), it belongs to the sub-category X of the object model 2 for the firm B.”

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A computer system comprising:
means for storing data, wherein data are allocated to predetermined categories that are components of at least one stored categorical structure forming an object model, wherein attributes that are passed on within the categorical structure are allocated to the categories;
at least one inquiry unit for making inquiries relating to the stored data; and
at least one inference unit used to evaluate rules linking at least one of said categories and said attributes.

2. The computer system according to claim 1, wherein rules are provided for linking data to at least one of other data, categories, and objects.

3. The computer system according to claim 1, wherein the at least one inference unit, by evaluating said rules, obtains as an output variable at least one of a predetermined subset or a correlation between subsets, wherein the subset or subsets may be at least one of subsets of categories, attributes, and data.

4. The computer system according to claim 1, wherein only simple inheritances are permitted for a categorical structure.

5. The computer system according to claim 1, wherein multiple inheritances are permitted for a categorical structure.

6. The computer system according to claim 1, wherein the rules function to link at least one of categories, attributes, and data of different object models.

7. The computer system according to claim 1, wherein interrelations between stored information of various object models are generated by evaluating the rules of the at least one inference unit.

8. The computer system according to claim 7, wherein the stored information of various object models comprises at least one of categories, attributes, and data.

9. The computer system according to claim 1, wherein the object model is embodied as a DAML+OIL model.

10. The computer system according to claim 9, wherein the rules are in the DAML−L language.

11. The computer system according to claim 1, further comprising a memory unit, associated with the at least one inference unit, in which a predetermined number of rules are stored.

12. The computer system according to claim 1, further comprising an input/output unit connected to the at least one inference unit, wherein the input/output unit is used to input inquiry commands for activating the at least one inference unit.

13. The computer system according to claim 12, wherein a predetermined number of inquiry-specific rules are evaluated when an inquiry command is input into the at least one inference unit.

14. The computer system according to claim 12, wherein the results obtained during the evaluation of the rules in the at least one inference unit are output via the input/output unit.

15. The computer system according to claim 1, wherein said means for storing data comprises a database system.

16. The computer system according to claim 15, wherein the computer system comprises more than one computer.

17. The computer system according to claim 16, further comprising a network to which each computer is connected, and wherein each computer has a database system installed.

18. The computer system according to claim 16, wherein each computer is provided with an Internet connection.

19. The computer system according to claim 16, wherein at least one of categories, attributes, and data from various object models, installed on different computers, are correlated by evaluating the rules in at least one inference unit.

20. The computer system according to claim 19, wherein the at least one inference unit functions as an interface unit for exchanging information between two computers, wherein said interface unit evaluates the rules in order to generate a bi-directional allocation of at least one of categories, attributes, and data for one object model installed on a first computer and of at least one of categories, attributes, and data for a second object model installed on a second computer.

21. A method of storing and retrieving data in a computer system, the method comprising the steps of:
generating a categorical structure in the form of an object model, the categorical structure including categories and attributes associated with the categories, wherein the categories and associated attributes are passed on within the categorical structure;
storing data in the categories within the categorical structure; and
processing at least one inquiry to obtain output by evaluating rules for linking at least one of said categories and attributes with another at least one of said categories and attributes.

22. The method according to claim 21, wherein the step of processing further comprises the step of:
using rules to link data with at least one of other data, categories, and attributes.

23. The method according to claim 21, further comprising the step of:
outputting at least one output variable, in response to said at least one inquiry, the at least one output variable comprising at least one of a subset or a correlation between subsets of at least one of categories, attributes, and data.

24. The method according to claim 21, further comprising the step of:
linking at least one of categories, attributes, and data from different object models using said rules.

25. The method according to claim 24, further comprising the step of:
outputting at least one output variable comprising at least one interrelation between at least one of categories, attributes, and data from various object models.

26. The method according to claim 24, wherein the different object models are stored on different computer systems connected to a network.

27. The method according to claim 26, wherein the network comprises the Internet.

28. The method according to claim 24, wherein the step of processing at least one inquiry further comprises the step of:
entering by a user of one computer system an inquiry applicable to data stored on at least one other computer system.

29. A computer system including a processor executing the method according to claim 21.

30. A computer-readable medium containing software code implementing the method according to claim 21.

31. A computer system comprising:
at least one processor; and
at least one computer-readable medium according to claim 30.

32. The computer system according to claim 31, wherein the at least one processor comprises a plurality of processors, and further comprising:
a network connecting the plurality of processors.

33. A modulated data signal carrying the software code embodied on the computer-readable medium according to claim 30.
